(19) United States
(12) Patent Application Publication
(10) Pub. No.: US 2007/0063047 A1
(43) Pub. Date: Mar. 22, 2007

(54) Image generation apparatus, print method, storage medium, print medium group, and information retention system

(75) Inventor: Kimitake Hasuike, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/341,516

(22) Filed: Jan. 30, 2006

(30) Foreign Application Priority Data
Sep. 14, 2005 (JP) P2005-266871

(51) Int. Cl. G06K 7/10

(52) U.S. Cl. 235/462.31

(57) ABSTRACT

An image generation apparatus comprises: an acquisition unit that acquires first position information for determining a position in a first area provided on a first medium plane and second position information for determining a position in a second area provided on a second medium plane, the second position information having continuity with the first position information; and a generation unit that generates a first code image printed in the first area from the first position information and generates a second code image printed in the second area from the second position information.

### BACKGROUND OF THE INVENTION

1. Field of the Invention

This invention relates to an image generation apparatus for generating a code image, a print method for printing a code image, and the like.

2. Description of the Related Art

In recent years, attention has been focused on an art for enabling the user to draw characters or a picture on special paper with fine dots printed thereon and transfer data of the characters, etc., written on the paper to a personal computer, a mobile telephone, etc., for retaining the data and executing mail transmission. In this art, small dots are printed on the special paper with a spacing of about 0.3 mm, for example, so as to draw different patterns for each grid of a predetermined size, for example. The paper is read with a dedicated pen incorporating a digital camera, for example, whereby the positions of the characters, etc., written on the special paper can be determined and it is made possible to use such characters, etc., as electronic information.

An art of printing an electronically stored document on a paper sheet provided with a position coding pattern is previously known as a related art. In this art, a special paper sheet provided with a position coding pattern is also used. A document is printed on the paper sheet, manual edit is executed on the paper sheet using a digital pen including a position coding pattern read unit and a pen point for marking the paper surface, and the edit result is reflected on electronic information. In the related art described above, it is desirable that document information should be printed together with the position coding pattern.

However, in the related art described, the position coding pattern printed on a paper sheet is continuous on the paper sheet and the ease of use may worsen in some specific applications; this is a problem.

For example, use of a paper sheet provided with such a position coding pattern for a questionnaire is considered. That is, paper sheets each provided with handwritten answer fields to several questions are distributed to persons and the handwritten descriptions in the answer fields are totalized. In this case, in the method of giving continuous position information for each paper sheet as in JP-A-2003-528388, to totalize the answers, it is necessary to understand which position on the paper sheet corresponds to the question to be totalized by consulting a database, etc., and the totalization processing involves a large calculation amount.

With continuous position information given for each questionnaire, personal information of the name, etc., and the answer descriptions are retained together and thus this situation is unfavorable from a security standpoint.

Further, it is also possible that persons draw pictures and sketches on paper sheets each provided with a position coding pattern and the paper sheets are combined into one picture or sketch (drawing). Also in this case, processing for later combining the pictures and sketches (drawings) would become intricate.

### SUMMARY OF THE INVENTION

The present invention has been made in view of the above circumstances and provides an image generation apparatus.

According to an aspect of the invention, an image generation apparatus includes an acquisition unit that acquires first position information for determining a position in a first area provided on a first medium plane and second position information for determining a position in a second area provided on a second medium plane, the second position information having continuity with the first position information; and a generation unit that generates a first code image printed in the first area from the first position information and generates a second code image printed in the second area from the second position information.

Here, the generation unit can be configured so as to generate the first code image and the second code image from common identification information given to the first area and the second area. The generation unit can also be configured so as to generate the first code image from identification information of the first medium plane and generate the second code image from identification information of the second medium plane.

According to another aspect of the invention, a print method includes the steps of acquiring first position information for determining the position in a first are a provided on a first medium plane; printing a code image representing the first position information in the first area; acquiring second position information for determining the position in a second area provided on a second medium plane, the second position information having continuity with the first position information; and printing a code image representing the second position information in the second area.

According to another aspect of the present invention, a storage medium is readable by a computer, and stores a program of instructions executable by the computer to perform a function. In this case, the function comprises acquiring first position information for determining the position in a first area provided on a first medium plane and second position information for determining the position in a second area provided on a second medium plane, the second position information having continuity with the first position information; and a function of generating a first code image printed in the first area from the first position information and generating a second code image printed in the second area from the second position information.

According to another aspect of the present invention, a print medium group includes a first print medium having a first area and a second print medium having a second area; a first code image representing first position information for determining the position in the first area is printed in the first area, and a second code image representing second position information for determining the position in a second area, the second position information having continuity with the first position information, is printed in the second area.

According to another aspect of the present invention, an information retention system includes a read unit that reads first information written into a first area provided on a first medium plane and second information written into a second area provided on a second medium plane; a recognition unit that recognizes continuity between first position information for determining the position in the first area and second position information for determining the position in the second area; and a retention unit that retains the first information and the second information in a layout responsive to the continuity.

### BRIEF DESCRIPTION OF THE DRAWINGS

Embodiments of the present invention will be described in detail based on the following figures, wherein:

FIG. 1 is a drawing to show the general configuration of a system incorporating an embodiment of the invention;

FIG. 2 is a drawing to describe an outline of the embodiment of the invention;

FIG. 3 is a block diagram to show the functional configuration of an identification information management server in the embodiment of the invention;

FIG. 4 is a drawing to show an example of media output in a first embodiment of the invention;

FIG. 5 is a drawing to show an example of identification information and position information assigned to media output in the first embodiment of the invention;

FIG. 6 is a flowchart to show the operation of a correspondence information management section in the first embodiment of the invention;

FIG. 7 is a flowchart to show the operation of the correspondence information management section in the first embodiment of the invention;

FIG. 8 is a drawing to show an example of media output in a second embodiment of the invention;

FIG. 9 is a drawing to describe the size of each area in the media output in the second embodiment of the invention;

FIG. 10 is a drawing to show an example of identification information and position information assigned to media output in the second embodiment of the invention;

FIG. 11 is a flow chart to show the operation of correspondence information management section in the second embodiment of the invention;

FIG. 12 is a drawing to describe a two-dimensional code image printed on a medium in the embodiment of the invention; and

FIG. 13 is a drawing to show a configuration example of an image formation apparatus in the embodiment of the invention.

### DETAILED DESCRIPTION OF THE INVENTION

The best mode for carrying out the invention (embodiments) will be discussed below in detail with reference to the accompanying drawings.

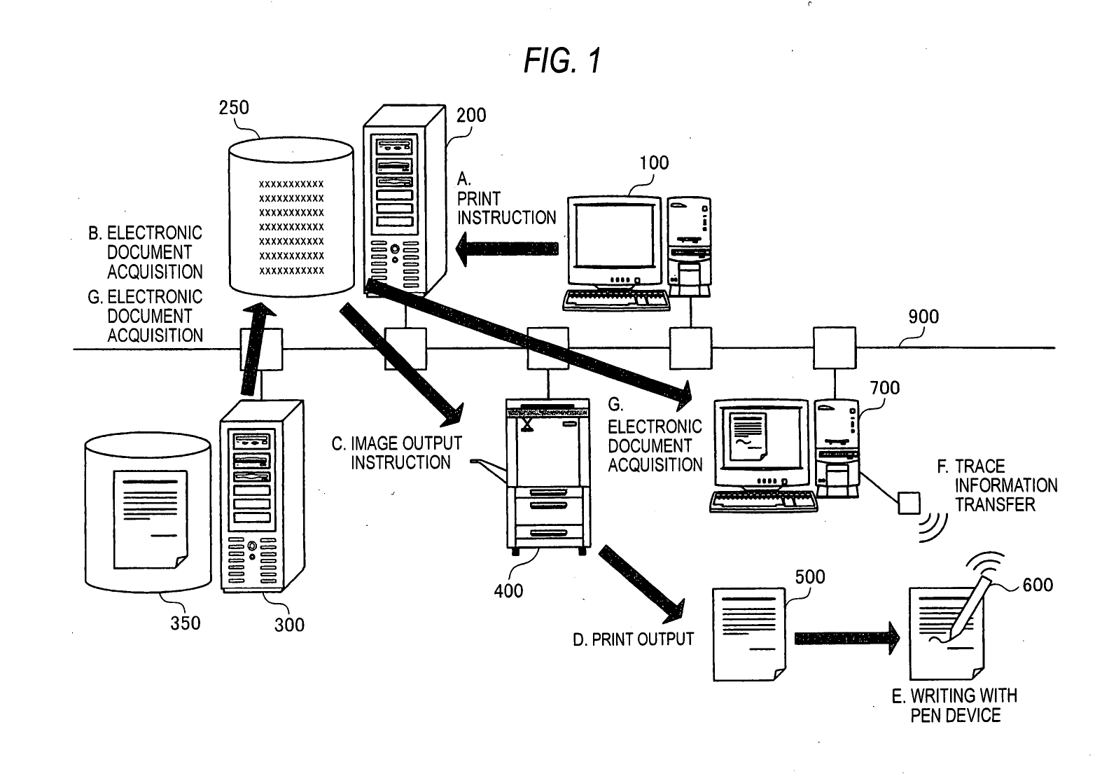

FIG. 1 shows a configuration example of a system incorporating an embodiment of the invention. This system is made up of at least a terminal 100 for giving a print instruction of an electronic document, an identification information management server 200 for managing identification information given to a medium in printing an electronic document and generating an image having a code image containing the identification information, etc., superposed on the image of the electronic document, a document management server 300 for managing electronic documents, and an image formation apparatus 400 for printing an image having a code image superposed on an image of an electronic document, the components 100, 200, 300, and 400 being connected to a network 900.

An identification information repository 250 as storage for storing identification information is connected to the identification information management server 200, and a document repository 350 as storage for storing electronic documents is connected to the document management server 300.

Further, the system includes printed matter 500 output on the image formation apparatus 400 as instructed from the terminal 100 and a pen device 600 for recording text or a graphic form on the printed matter 500 and reading record information of the text or the graphic form. A terminal 700 for superposing an electronic document managed in the document management server 300 and the record information read with the pen device 600 on each other for display is also connected to the network 900.

The expression “electronic document” used throughout the Specification means not only electronized data of a “document” containing text, but also image data of a picture, a photo, a graphic form, etc., (regardless of raster data or vector data) and any other printable electronic data, for example.

An outline of the operation of the system will be discussed:

First, the terminal 100 instructs the identification information management server 200 to superpose a code image on an image of an electronic document managed in the document repository 350 and print (A). At this time, from the terminal 100, the print attributes of the paper size, the orientation, the number of sheets, scale-down/scale-up, N-up (print with N pages of electronic document laid out within one page of paper), double-sided printing, etc., are also input. Accordingly, the identification information management server 200 acquires the electronic document whose printing is instructed from the document management server 300 (B). The identification information management server 200 gives a code image containing the identification information managed in the identification information repository 250 and position information determined as required to the image of the acquired electronic document, and instructs the image formation apparatus 400 to print (C). The identification information is information for uniquely identifying each medium (paper) on which the image of the electronic document is printed, and the position information is information for determining the coordinate position (X coordinate, Y coordinate) on each medium.

Then, the image formation apparatus 400 outputs printed matter 500 in accordance with the instruction from the identification information management server 200 (D).

The image formation apparatus 400 forms the code image given by the identification information management server 200 as an invisible image in invisible toner and any other image (image in the portion contained in the original electronic document) in visible toner as described later in detail.

On the other hand, it is assumed that the user records (writes) text or a graphic form on the printed matter 500 with the pen device 600 (E). Accordingly, the image pickup device of the pen device 600 captures a given area on the printed matter 500 and provides identification information and position information. Trace information of the text or the graphic form found based on the position information and the identification information are transferred to the terminal 700 in a wireless or wired manner (F). The system makes it possible to form an invisible image using invisible toner having a higher absorption rate of infrared light than a predetermined criterion and read the invisible image with the pen device 600 capable of applying and detecting infrared light.

Then, the terminal 700 transmits the identification information to the identification information management server 200, thereby requesting the identification information management server 200 to transmit the electronic document corresponding to the identification information. Upon reception of the request, the identification information management server 200 acquires the electronic document corresponding to the identification information from the document management server 300, and transmits the electronic document to the terminal 700 (G). Consequently, the electronic document sent from the identification information management server 200 and the trace information sent from the pen device 600 are combined for display on the terminal 700.

However, such a configuration is only an example. For example, one server may be provided with both the function of the identification information management server 200 and the function of the document management server 300. The function of the identification information management server 200 may be implemented in an image processing section of the image formation apparatus 400. Further, the terminals 100 and 700 may be a single terminal.

Next, an outline of the embodiment will be discussed.

In the embodiment, if the user wants to combine handwritten letters, etc., written into specific areas on different media for retention, position information consecutive across the different media is given to the specific areas.

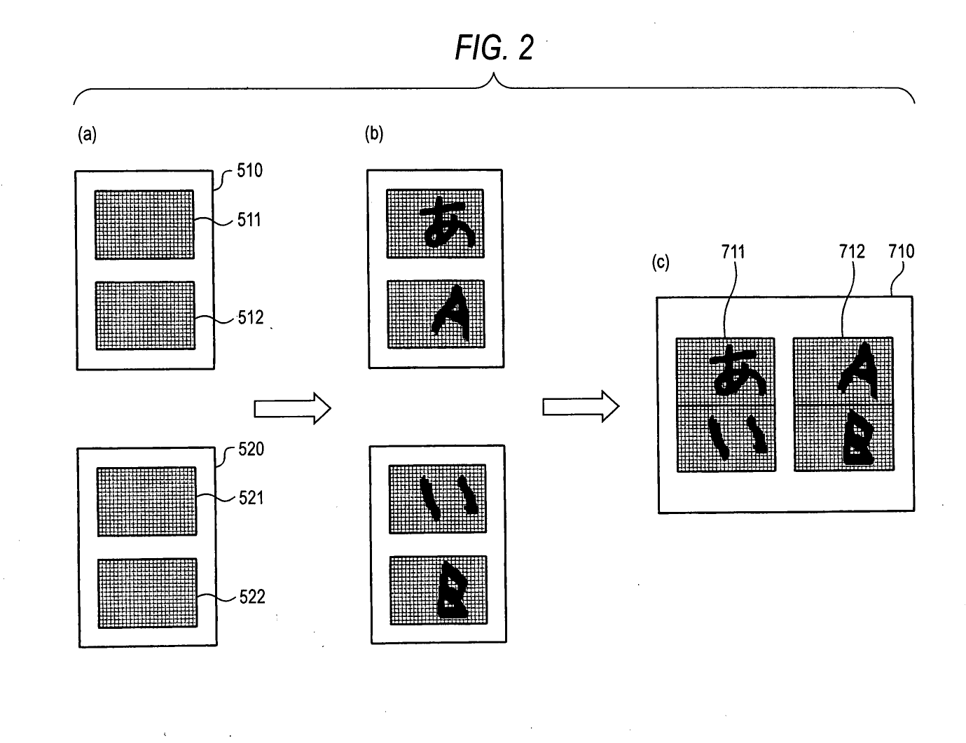

FIG. 2 shows a flow of handwriting on two media and retaining the handwritten description.

FIG. 2 (a) shows addressed documents 510 and 520 output in the embodiment. As shown in the figure, the addressed document 510 is provided with areas 511 and 512. The addressed document 520 is provided with areas 521 and 522. It is assumed that code images representing the consecutive position information are printed in the areas 511 and 521 and the areas 512 and 522.

It is assumed that handwriting as shown in FIG. 2 (b) is applied to the addressed documents 510 and 520. That is, a hiragana (Japanese character) is written into the area 511, “A” is written into the area 512, another hiragana is written into the area 521, and “B” is written into the area 522.

Then, the handwritten letters are retained as shown in FIG. 2 (c). That is, the handwriting into the areas 511 and 521 given the consecutive position information is retained in storage 710 as consecutive data 711 and the handwriting into the areas 512 and 522 given the consecutive position information is retained as consecutive data 712.

The operation at this time will be discussed in more detail. For example, a read unit (for example, the pen device 600 in FIG. 1) reads the information written into the area 511 and the information written into the area 521. A recognition unit (for example, the pen device 600 in FIG. 1) recognizes continuity between the position information given to the area 511 and the position information given to the area 521. After this, a retention unit (for example, provided in the terminal 700) retains the information read from the area 511 and the information read from the area 521 in a layout as shown in FIG. 2 (c).

The configuration and the operation of the system for outputting media with consecutive position information given to specific areas on different media like the addressed documents 510 and 520 will be discussed below in detail:

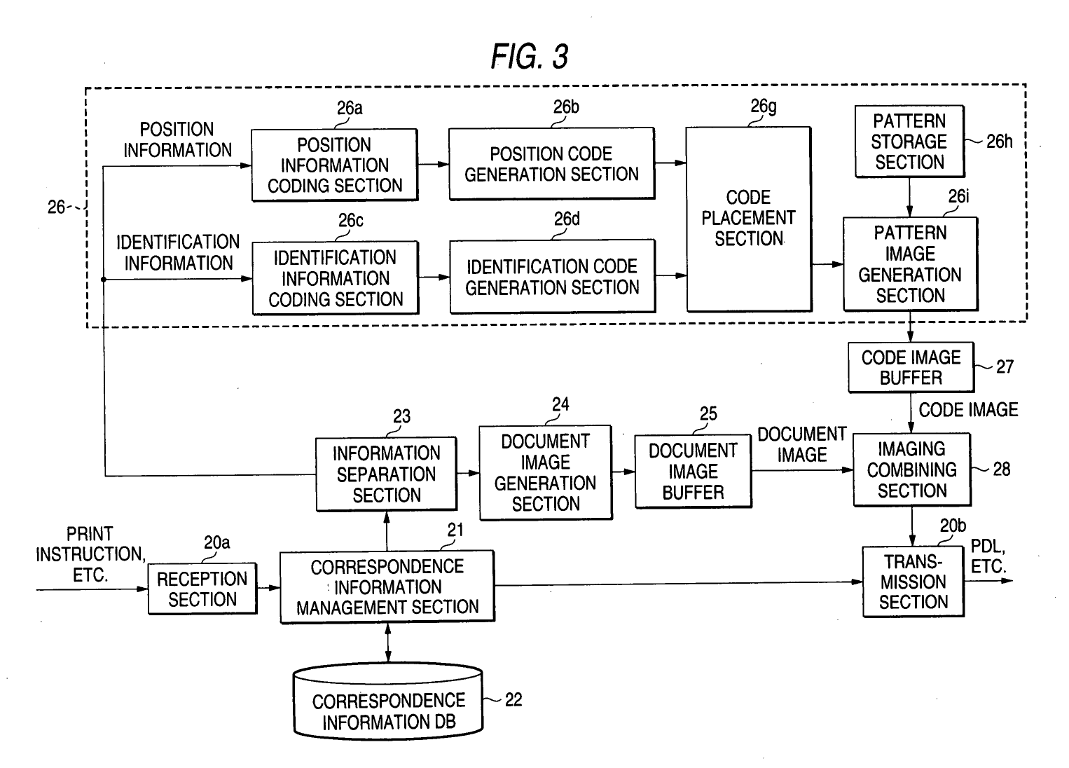

FIG. 3 is a block diagram to show a configuration example of the identification information management server 200.

The identification information management server 200 includes a reception section 20a, a correspondence information management section 21, a correspondence information database (DB) 22, an information separation section 23, a document image generation section 24, a document image buffer 25, a code image generation section 26, a code image buffer 27, an image combining section 28, and a transmission section 20b.

The code image generation section 26 includes a position information coding section 26a, a position code generation section 26b, an identification information coding section 26c, an identification code generation section 26d, a code placement section 26g, a pattern storage section 26h, and a pattern image generation section 26i.

The reception section 20a receives a print instruction, etc., sent from the terminal 100 from the network 900.

The correspondence information management section 21 acquires identification information and position information and registers the correspondence between the identification information and the position information in the correspondence information DB 22, for example. Thus, the correspondence information management section 21 can be interpreted as an acquisition unit from the viewpoint of acquiring the identification information and the position information.

The correspondence information DB 22 is a database as a storage section for storing the correspondence between the identification information identifying the medium side and document information concerning the electronic document as a source of the image printed on the medium side.

The information separation section 23 separates the information transferred from the correspondence information management section 21 into information required for generating a document image and information required for generating a code image.

The document image generation section 24 converts the electronic document into an image based on the information required for generating a document image, provided by the information separation section 23 and stores the image in the document image buffer 25.

The code image generation section 26 generates a code image based on the information required for generating a code image, provided by the information separation section 23 and stores the code image in the code image buffer 27. Thus, the code image generation section 26 can be interpreted as a generation unit from the viewpoint of generating the code image.

The image combining section 28 combines the document image stored in the document image buffer 25 and the code image stored in the code image buffer 27. Thus, the image combining section 28 can be interpreted as a combining unit from the viewpoint of combining the images.

The transmission section 20b transmits an instruction for outputting the image provided by the image combining section 28 to the image formation apparatus 400 as a PDL (Page Description Language) typified by PostScript, etc.

When the position information is input, the position information coding section 26a codes the position information according to a predetermined coding system. For example, RS (Reed-Solomon) code and BCH code of already known error correction codes can be used for the coding. CRC (cyclic redundancy check) or check sum value of the position information is calculated as error detection code and can be added to the position information as a redundancy bit. M series code of a kind of pseudo-noise series can also be used as the position information. For the M series code, coding is performed using the nature that for P-order M series (series length 2^{P-1}), when the partial series of length P is taken out from the M series, the bit pattern appearing in the partial series appears only once in the M series.

The position code generation section 26b converts the coded position information into an embedded format as code information. For example, the placement of the bits in the coded position information can be replaced using pseudo random numbers, etc., or can be encrypted so that a third party becomes hard to interpret the information. If the position code is placed two-dimensionally, the bit value is placed two-dimensionally like the code placement.

When the identification information is input, the identification information coding section 26c codes the identification information according to a predetermined coding system. For the coding, a similar system to that used for coding the position information can be used.

The identification code generation section 26d converts the coded identification information into an embedded format as code information. For example, the placement of the bits in the coded identification information can be replaced using pseudo random numbers, etc., or can be encrypted so that a third party becomes hard to interpret the information. If the identification code is placed two-dimensionally, the bit value is placed two-dimensionally like the code placement.

The code placement section 26g combines the coded position information and the coded identification information placed in the same format as the code to generate a two-dimensional code array corresponding to the output image size. At this time, code provided by coding the position information varying depending on the placement position is used as the coded position information, and code provided by coding the same information independently of the position is used as the coded identification information.

The pattern image generation section 26i checks the bit values of the array elements of the two-dimensional code array, acquires a bit pattern image corresponding to each bit value from the pattern storage section 26h, and outputs the two-dimensional code array as a code image thereof.

The functional portions are implemented as the software and hardware resources cooperate. Specifically, a CPU (not shown) of the identification information management server 200 reads programs for implementing the functions of the reception section 20a, the correspondence information management section 21, the information separation section 23, the document image generation section 24, the code image generation section 26, the image combining section 28, and the transmission section 20b into main storage from external storage.

Next, the specific operation for the identification information management server 200 to transmit an image output instruction to the image formation apparatus 400 in response to a print instruction from the terminal 100 will be discussed.

Here, the following two embodiments are considered as examples wherein it is preferable that consecutive position information is printed in the corresponding areas on different media:

A first embodiment concerns questionnaires. That is, a plurality of media provided with entry fields of the same size at the same positions are provided and it is made possible to retain handwritten answers written into the corresponding entry fields on the media together.

A second embodiment is intended for persons to create pictures or sketches (drawings) finally combined into one in cooperation. That is, each person receives distribution of paper to perform work of one part of the whole (which will be hereinafter referred to as “partial work paper”) and performs the work in his or her charge. In this case, the positions and the sizes of entry fields in the partial work paper are not necessarily the same, but it is made possible to join a picture or a sketch (drawing) drawn in any entry field of one partial work paper and a picture or a sketch (drawing) drawn in any entry field of any other partial work paper for retention.

### First Embodiment

In the first embodiment of the invention, to output a plurality of media provided with areas (entry fields) of the same size at the same positions, consecutive position information across the media is given to the areas, as described above.

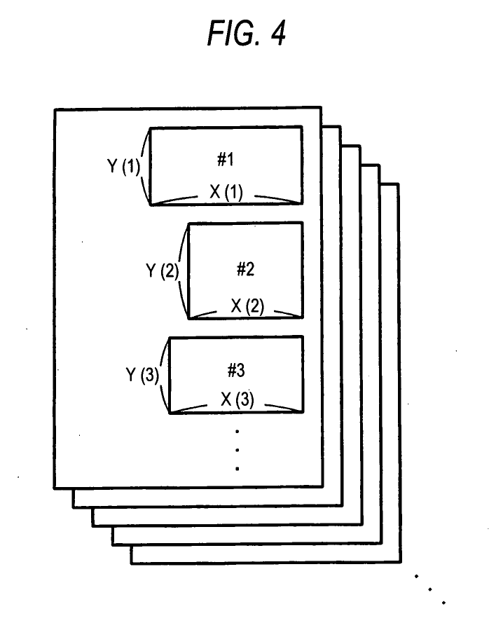

FIG. 4 is a drawing to show an image of output media. It shows only the first medium because the positions and the sizes of the areas on the media are the same. For example, it is assumed that one medium is provided with areas of sizes as shown in the figure at positions as shown in the figure. Consecutive position information across the media is given to the areas. In the embodiment, as for area #j, the size in a lateral direction (X direction) is represented as “X(j)” and the size in a longitudinal direction (Y direction) is represented as “Y(j).”

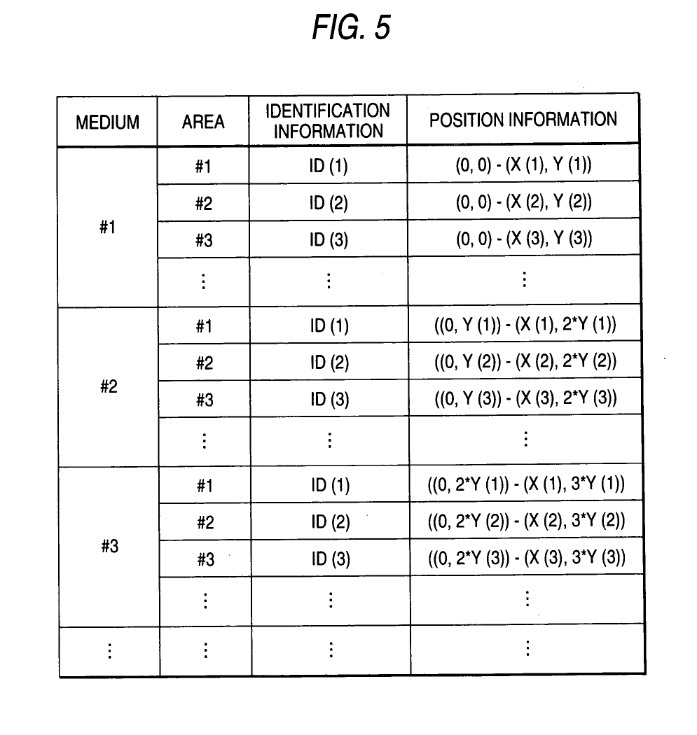

FIG. 5 shows identification information and position information assigned to areas #1 to #3 of each medium shown in FIG. 4.

Here, as the identification information, ID (1) is assigned to area #1, ID (2) is assigned to area #2, and ID (3) is assigned to area #3. That is, the same identification information is assigned to the area of the same number regardless of which of media #1 to #3 the area exists on. It may be a common practice to assign unique identification information to each medium; in the embodiment, however, identification information assigned to each area is adopted. Accordingly, answers to questionnaires are separated from other areas of the same questionnaire and it is made impossible to again join them tracing the identification information. That is, the questionnaire answerer and his or her answers can be separated for providing data, so that the system also provides a merit from the aspect of protection of personal information.

The position information is given so that the areas of the same number on different media are placed consecutively in the Y direction. That is, the position information assigned to area #1 is from (0, 0) to (X (1), Y (1)) on medium #1; from (0, Y (1)) to (X (1), 2*Y (1)) on medium #2; and from (0, 2*Y 1)) to (X (1), 3*Y (1)) on medium #3. The position information assigned to area #2 is also determined in a similar manner using X (2), Y (2), and the position information assigned to area #3 is also determined in a similar manner using X (3), Y (3).

The specific operation for giving such identification information and position information will be discussed below:

In the identification information management server 200, first the reception section 20a receives a print instruction containing an electronic document as a source of a questionnaire (which will be hereinafter referred to as “questionnaire document”) and print attributes from the terminal 100, and passes the received information to the correspondence information management section 21.

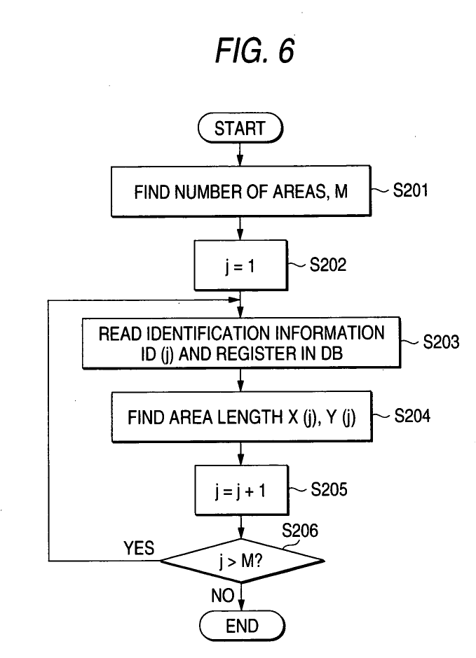

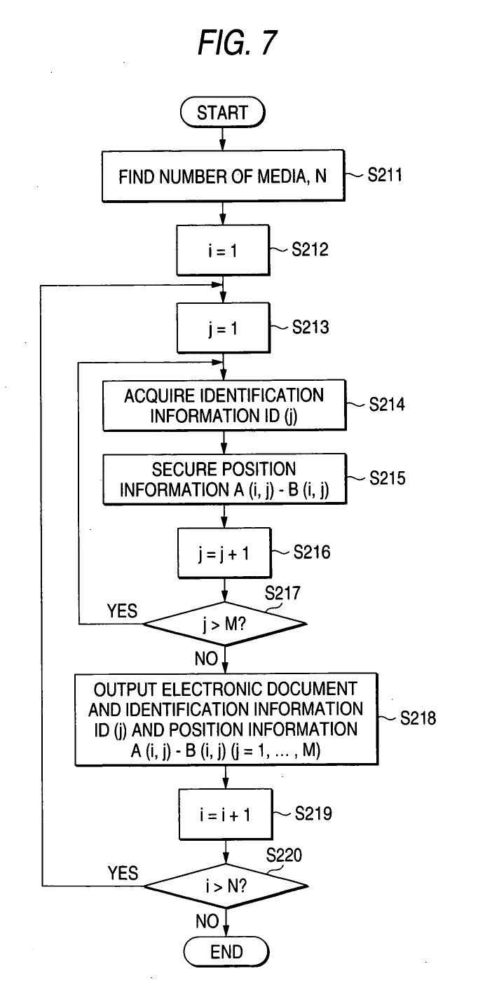

Accordingly, the correspondence information management section 21 performs processing as shown in FIGS. 6 and 7.

That is, in the embodiment, a plurality of questionnaires are output from one page of the questionnaire document passed from the reception section 20a. Thus, the area size is determined from one page of the questionnaire document in FIG. 6, and position information is determined for all media based on the determined area size in FIG. 7.

First, as shown in FIG. 6, the correspondence information management section 21 finds the number of areas contained in the questionnaire document, M (step 201).

Next, “1” is assigned to an index j for counting the number of areas (step 202). Identification information ID (1) of area #1 is read from the identification information repository 250 and is registered in the correspondence information DB 22 (step 203). In registration of the identification information in the correspondence information DB 22, the fact that the identification information ID (1) is already assigned may be managed or the correspondence between the identification information ID (1) and document information may be managed. If the former management is conducted, to read new identification information, the correspondence information DB 22 is consulted, whereby dual delivery of identification information can be prevented. As the latter management, it is possible to previously determine the file name of a file for retaining the answers of all answerers to the same item of the questionnaire document and associate the file name with identification information for enabling later reference.

Next, the correspondence information management section 21 finds X (1) and Y (1) as size information of area #1 (step 204). Which area is the area given the consecutive position information may be specified by the user when entering a print command in the terminal 700 or may be automatically determined by a computer analyzing the image of the questionnaire document.

One is added to j (step 205) and whether or not j exceeds M is determined (step 206).

If it is not determined that j exceeds M, steps 203 to 205 are executed for j=2 and again the determination at step 206 is made. The processing is repeated until j exceeds M.

On the other hand, if it is determined that j exceeds M, the processing is terminated.

Then, the correspondence information management section 21 performs processing of determining position information for each medium, as shown in FIG. 7.

First, the correspondence information management section 21 acquires the number of media to which the print instruction is applied, N, from the print attributes (step 211).

Next, “1” is assigned to an index i for counting the number of media (step 212). Also, “1” is assigned to an index j for counting the number of areas (step 213).

The identification information ID (1) of area #1 read at step 203 is acquired (step 214). Position information A (1, 1)-B (1, 1) to be assigned to area #1 of medium #1 is secured (step 215). Here, A (i, j) indicates the start point of the position information assigned to area #j of medium #i and B (i, j) indicates the end point of the position information assigned to area #j of medium #i. In the embodiment, A (i, j)=(0, (i−1)*Y (j)) and B (i, j)=(X (j), i*Y (j)).

Next, the correspondence information management section 21 adds one to j (step 216) and determines whether or not j exceeds M (step 217).

If it is not determined that j exceeds M, steps 214 to 216 are executed for j=2 and again the determination at step 217 is made. The processing is repeated until j exceeds M.

On the other hand, if it is determined that j exceeds M, the electronic document and identification information ID (j) and position information A (1, j)-B (1, j) (j=1, 2, . . . , M) are output to the information separation section 23 (step 218).

One is added to i (step 219) and whether or not i exceeds N is determined (step 220).

If it is not determined that i exceeds N, steps 213 to 219 are executed for i=2 and again the determination at step 220 is made. The processing is repeated until i exceeds N.

On the other hand, if it is determined that i exceeds N, the processing is terminated.

Then, the identification information management server 200 operates as follows:

The information separation section 23 separates the passed information into information required for code generation (identification information and position information) and information required for generating a document image (electronic document) and outputs the former information to the code image generation section 26 and the latter to the document image generation section 24.

Accordingly, the position information coding section 26a codes the position information and the position code generation section 26b generates position code indicating the coded position information, namely, generates the position code indicating the position information shown in FIG. 5 for the areas of the media.

The identification information coding section 26c codes the identification information and the identification code generation section 26d generates identification code indicating the coded identification information, namely, generates the identification code indicating the identification information shown in FIG. 5 for the areas of the media.

The code placement section 26g generates a two-dimensional code array corresponding to the output image size and the pattern image generation section 26i generates a pattern image corresponding to the two-dimensional code array.

On the other hand, the document image generation section 24 generates a document image of the electronic document.

Last, the image combining section 28 combines the document image generated by the document image generation section 24 and the code image previously generated by the code image generation section 26, and passes the resultant image to the transmission section 20b, which then transmits an instruction for outputting the resultant image provided by the image combining section 28 to the image formation apparatus 400.

The image formation apparatus 400 prints the resultant image of the document image of the electronic document to be printed and the code image on media in response to the image output instruction, and the user is provided with printed matter 500 (addressed document 510, 520).

In the embodiment, the same position information is given to the boundary between the two areas given the consecutive position information. For example, the same position information (0, Y (1))-(X (1), Y (1)) is given to the boundary between area #1 of medium #1 and area #1 of medium #2. However, consecutive position information may be given without giving the same position information. That is, if the position information given to area #1 of medium #1 ends with (X (1), Y (1)), the position information given to area #1 of medium #2 may be started at (0, Y (1)+1).

Thus, in the embodiment, consecutive position information across questionnaires is given to the corresponding entry fields of the questionnaires distributed to persons. Accordingly, it becomes easy to retain the answers of the answerers to the same question collectively.

If the embodiment is applied to an achievement test, etc., it becomes easy to retain the answers for each question, whereby it also becomes easy to pass the answers for each question to markers.

### Second Embodiment

In the second embodiment of the invention, to output a plurality of media provided with areas (entry fields) whose positions and sizes are not necessarily the same, consecutive position information across the media is given to the areas, as described above.

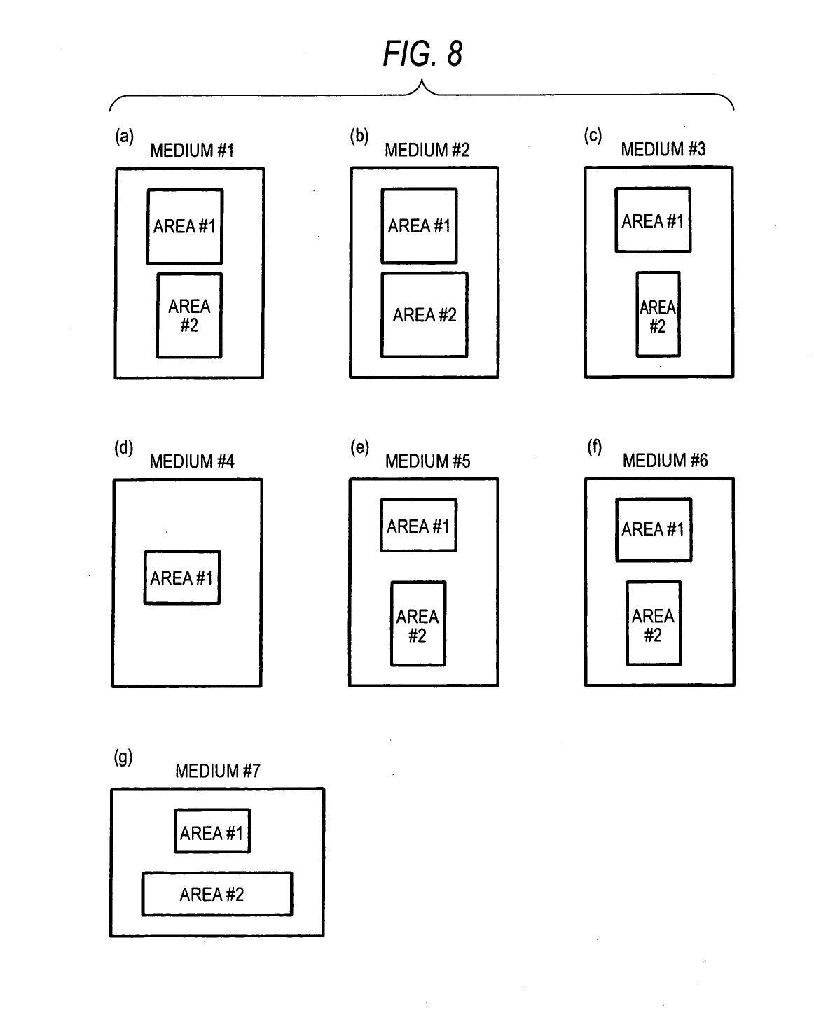

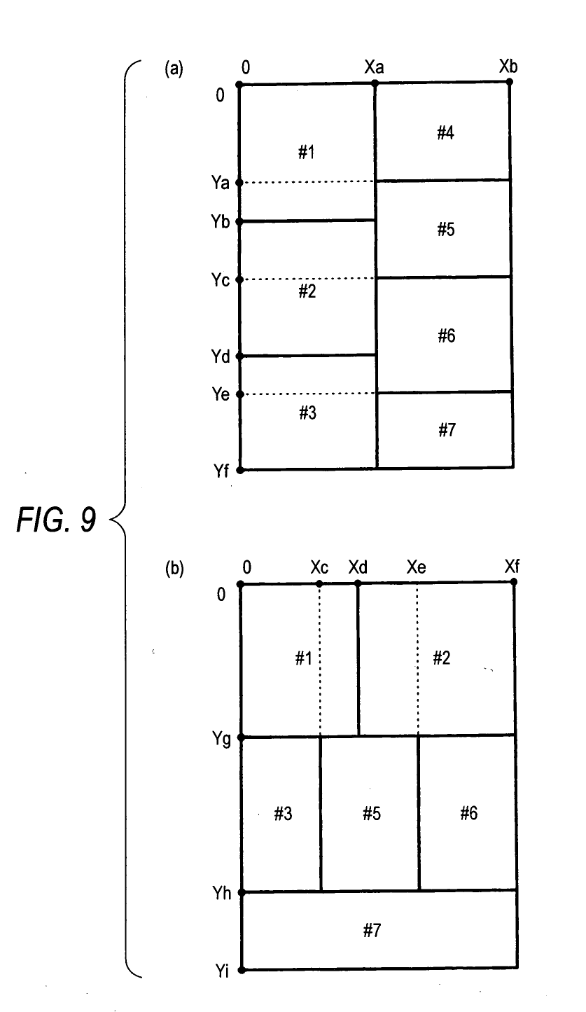

FIG. 8 is a drawing to show an image of output media. Here, it is assumed that seven media #1 to #7 shown in FIG. 8 (a) to FIG. 8 (g) are output. Areas #1 of the media are joined to a medium as in FIG. 9 (a), and areas #2 of the media are joined to a medium as in FIG. 9 (b). That is, one picture is completed from the pictures drawn in areas #1 of the media and another picture is completed from the pictures drawn in areas #2 of the media.

The size of each area will be discussed. The areas cut out from the media are placed with no space, as shown in FIG. 9. Here, “#i” in FIG. 9 means that the area is cut out from medium #i.

First, for the medium in FIG. 9 (a), assuming that the upper left point is the origin, coordinates A (i, 1) of the upper left point and coordinates B (i, 1) of the lower right point of the area cut out from medium #i are as follows:

A (1, 1)=(0, 0), B (1, 1)=(Xa, Yb)

A (2, 1)=(0, Yb), B (2, 1)=(Xa, Yd)

A (3, 1)=(0, Yd), B (3, 1)=(Xa, Yf)

A (4, 1)=(Xa, 0), B (4, 1)=(Xb, Ya)

A (5, 1)=(Xa, Ya), B (5, 1)=(Xb, Yc)

A (6, 1)=(Xa, Yc), B (6, 1)=(Xb, Ye)

A (7, 1)=(Xa, Ye), B (7, 1)=(Xb, Yf)

For the medium in FIG. 9 (b), assuming that the upper left point is the origin, coordinates A (i, 2) of the upper left point and coordinates B (i, 2) of the lower right point of the area cut out from medium #i are as follows:

A (1, 2)=(0, 0), B (1, 2)=(Xd, Yg)

A (2, 2)=(Xd, 0), B (2, 2)=(Xf, Yg)

A (3, 2)=(0, Yg), B (3, 2)=(Xc, Yh)

A (4, 2)=none, B (4, 2)=none

A (5, 2)=(Xc, Yg), B (5, 2)=(Xe, Yh)

A (6, 2)=(Xe, Yg), B (6, 2)=(Xf, Yh)

A (7, 2)=(0, Yh), B (7, 2)=(Xf, Yi)

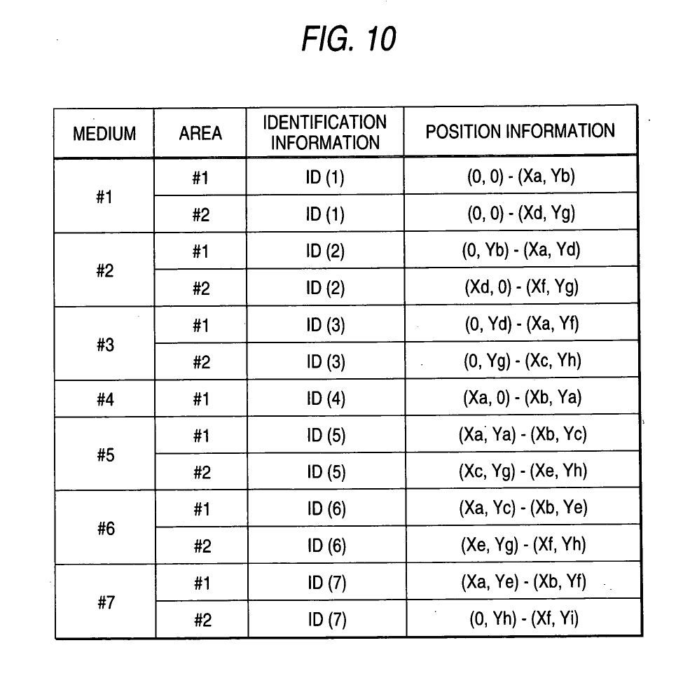

FIG. 10 shows identification information and position information assigned to the areas of media #1 to #7 shown in FIG. 8.

Here, as the identification information, ID (1) is assigned to medium #1, ID (2) is assigned to medium #2, ID (3) is assigned to medium #3, ID (4) is assigned to medium #4, ID (5) is assigned to medium #5, ID (6) is assigned to medium #6, and ID (6) is assigned to medium #7. That is, the same identification information is assigned to all areas on the same medium. Accordingly, the original pictures, etc., can be traced from the completed picture, etc.

The position information responsive to the positions of the areas in the media shown in FIG. 9 is given, as described above.

The specific operation for giving such identification information and position information will be discussed below:

In the identification information management server 200, first the reception section 20a receives a print instruction containing an electronic document as a source of partial work paper (which will be hereinafter referred to as “partial work document”) and print attributes from the terminal 100, and passes the received information to the correspondence information management section 21.

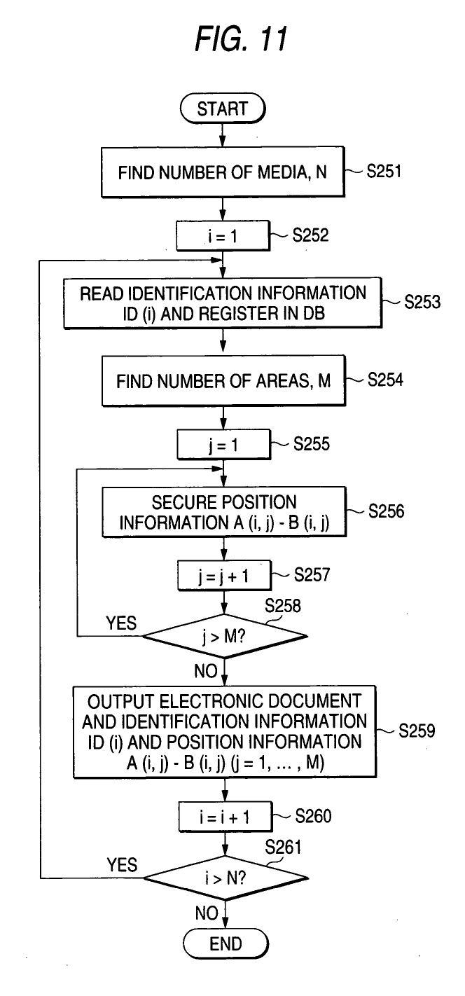

Accordingly, the correspondence information management section 21 performs processing as shown in FIG. 11.

That is, first the number of media to which the print instruction is applied, N, is acquired from the print attributes (step 251).

Next, “1” is assigned to an index i for counting the number of media (step 252). Identification information ID (1) of medium #1 is read from the identification information repository 250 and is registered in the correspondence information DB 22 (step 253). In registration of the identification information in the correspondence information DB 22, the fact that the identification information ID (1) is already assigned may be managed or the correspondence between the identification information ID (1) and document information may be managed. If the former management is conducted, to read new identification information, the correspondence information DB 22 is consulted, whereby dual delivery of identification information can be prevented. As the latter management, it is possible to associate the file name with identification information for enabling later reference to the partial work document.

The correspondence information management section 21 finds the number of areas contained in the partial work document, M (step 255).

Next, “1” is assigned to an index j for counting the number of areas (step 255).

Position information A (1, 1)-B (1, 1) to be assigned to area #1 of medium #1 is secured (step 256). Here, A (i, j) indicates the start point of the position information assigned to area #j of medium #i and B (i, j) indicates the end point of the position information assigned to area #j of medium #i. In the embodiment, it is assumed that the coordinate values of the upper left point and the lower right point of each area shown in FIG. 9 are previously stored in memory as A (i, j) and B (i, j).

Next, the correspondence information management section 21 adds one to j (step 257) and determines whether or not j exceeds M (step 258).

If it is not determined that j exceeds M, steps 256 and 257 are executed for j=2 and again the determination at step 258 is made. The processing is repeated until j exceeds M.

On the other hand, if it is determined that j exceeds M, the electronic document and identification information ID (1) and position information A (1, j)-B (1, j) (j=1, 2, . . . , M) are output to the information separation section 23 (step 259).

One is added to i (step 260) and whether or not i exceeds N is determined (step 261).

If it is not determined that i exceeds N, steps 253 to 260 are executed for i=2 and again the determination at step 261 is made. The processing is repeated until i exceeds N.

On the other hand, if it is determined that i exceeds N, the processing is terminated.

Then, the identification information management server 200 operates as follows:

The information separation section 23 separates the passed information into information required for code generation (identification information and position information) and information required for generating a document image (electronic document) and outputs the former information to the code image generation section 26 and the latter to the document image generation section 24.

Accordingly, the position information coding section 26a codes the position information and the position code generation section 26b generates position code indicating the coded position information, namely, generates the position code indicating the position information shown in FIG. 10 for the areas of the media.

The identification information coding section 26c codes the identification information and the identification code generation section 26d generates identification code indicating the coded identification information, namely, generates the identification code indicating the identification information shown in FIG. 10 for the areas of the media.

The code placement section 26g generates a two-dimensional code array corresponding to the output image size and the pattern image generation section 26i generates a pattern image corresponding to the two-dimensional code array.

On the other hand, the document image generation section 24 generates a document image of the electronic document.

Last, the image combining section 28 combines the document image generated by the document image generation section 24 and the code image previously generated by the code image generation section 26, and passes the resultant image to the transmission section 20b, which then transmits an instruction for outputting the resultant image provided by the image combining section 28 to the image formation apparatus 400.

The image formation apparatus 400 prints the resultant image of the document image of the electronic document to be printed and the code image on media in response to the image output instruction, and the user is provided with printed matter 500 (addressed document 510, 520).

In the embodiment, the same position information is given to the boundary between the two areas given the consecutive position information. For example, the same position information (0, Yb)-(Xa, Yb) is given to the boundary between area #1 of medium #1 and area #1 of medium #2. However, consecutive position information may be given without giving the same position information. That is, if the position information given to area #1 of medium #1 ends with (Xa, Yb), the position information given to area #1 of medium #2 may be started at (0, Yb+1).

Thus, in the embodiment, consecutive position information across partial work paper sheets is given to the corresponding entry fields of the partial work paper sheets distributed to persons. Accordingly, work of completing one picture into which the pictures, etc., drawn by the persons are combined is facilitated.

Next, the code image thus generated will be discussed specifically.

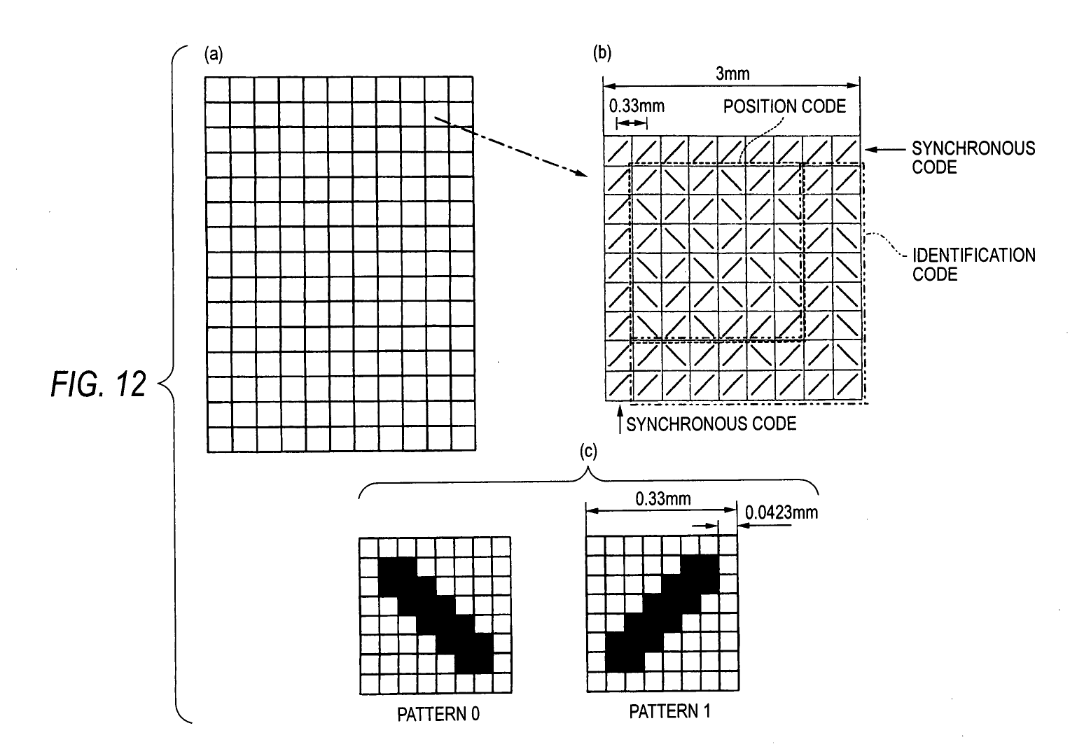

FIG. 12 (a) to FIG. 12 (c) are drawings to describe a two-dimensional code image generated by the code image generation section 26 of the identification information management server 200. FIG. 12 (a) is a drawing represented like a lattice to schematically show the units of a two-dimensional code image formed of an invisible image and placed. FIG. 12 (b) is a drawing to show one unit of the two-dimensional code image whose invisible image is recognized by infrared application. Further, FIG. 12 (c) is a drawing to describe slanting line patterns of a backslash “\” and a slash “/.”

The two-dimensional code image formed in the image formation apparatus 400 is formed of invisible toner with the maximum absorption rate in a visible light region (400 nm to 700 nm) being 7% or less, for example, and the absorption rate in a near infrared region (800 nm to 1000 nm) being 30% or more, for example. The invisible toner with an average dispersion diameter ranging from 100 nm to 600 nm is adopted to enhance the near infrared light absorption capability required for mechanical read of an image. Here, the terms “visible” and “invisible” do not relate to whether or not visual recognition can be made. The terms “visible” and “invisible” are distinguished from each other depending on whether or not an image formed on a printed medium can be recognized depending on the presence or absence of color development caused by absorption of a specific wavelength in a visible light region.

The two-dimensional code image shown in FIG. 12 (a) to FIG. 12 (c) is formed as an invisible image for which mechanical read by infrared application and decoding processing can be performed stably over a long term and information can be recorded at a high density. Preferably, the two-dimensional code image is an invisible image that can be provided in any desired area independently of the area where a visible image on the medium surface for outputting an image is provided. In the embodiment, the invisible image is formed on a full face of one side of a medium (paper face) matched with the size of a printed medium. Furthermore preferably, it is an invisible image that can be recognized based on a gloss difference in visual inspection. However, the expression “full face” is not used to mean the full face containing all four corners of paper. With an apparatus such as an electrophotographic apparatus, usually the margins of the paper face are often in an unprintable range and therefore an invisible image need not be printed in the range.

The two-dimensional code pattern shown in FIG. 12 (b) contains an area to store a position code indicating the coordinate position on the medium and an area to store an identification code for uniquely identifying the print medium. It also contains an area to store a synchronous code. As shown in FIG. 12 (a), a plurality of the two-dimensional code patterns are placed and two-dimensional codes storing different position information are placed like a lattice on the full face of one side of the medium (paper face) matched with the size of the printed medium. That is, a plurality of two-dimensional code patterns as shown in FIG. 12 (b) are placed on one side of the medium, each including a position code, an identification code, and a synchronous code. Different pieces of position information are stored in the areas of the position codes depending on the place where the position code is placed. On the other hand, the same identification information is stored in the identification code areas independently of the place where the identification code is placed.

In FIG. 12 (b), the position code is placed in a 6-bit×6-bit rectangular area. The bit values are formed as minute line bit maps different in rotation angle and slanting line patterns (patterns 0 and 1) shown in FIG. 12 (c) represent bit values 0 and 1. More specifically, bits 0 and 1 are represented using a backslash “\” and a slash “/” which are different in inclination. Each slanting line pattern is of a size of 8×8 pixels in 600 dpi; the slanting line pattern lowering to the right (pattern 0) represents the bit value 0 and the slanting line pattern rising to the right (pattern 1) represents the bit value 1. Therefore, one slanting line pattern can represent 1-bit information (0 or 1). Using such minute line bit maps involving two types of inclinations, it is made possible to provide two-dimensional code patterns with extremely small noise given to a visible image, the two-dimensional code patterns in which a large amount of information can be digitized and embedded at a high density.

That is, 36-bit position information is stored in the position code area shown in FIG. 12 (b). Of the 36 bits, 18 bits can be used to code X coordinates and 18 bits can be used to code Y coordinates. If the 18 bits for the X coordinates and those for the Y coordinates are all used for coding positions, 2¹⁸ (about 260000) positions can be coded. When each slanting line pattern is formed of 8×8 pixels (600 dpi) as shown in FIG. 12 (c), the size of the two-dimensional code (containing the synchronous code) in FIG. 12 (b) becomes about 3 mm in length and about 3 mm in width (8 pixels×9 bits×0.0423 mm) because one dot of 600 dpi is 0.0423 mm. To code 260000 positions with a 3-mm spacing, a length of about 786 m can be coded. All 18 bits may be thus used to code positions or if a detection error of a slanting line pattern occurs, a redundancy bit for error detection and error correction may be contained.

The identification code is placed in 2-bit×8-bit and 6-bit×2-bit rectangular areas and 28-bit identification information can be stored. To use 28 bits as the identification information, 2²⁸ (about two hundred and seventy million) pieces of identification information can be represented. A redundancy bit for error detection and error correction can be contained in the 28 bits of the identification code like the position code.

In the example shown in FIG. 12 (c), the two slanting line patterns differ in angle 90 degrees, but if the angle difference is set to 45 degrees, four types of slanting line patterns can be formed. In doing so, one slanting line pattern can represent 2-bit information (any of 0 to 3). That is, as the number of angle types of slanting line patterns is increased, the number of bits that can be represented can be increased.

In the example shown in FIG. 12 (c), coding of the bit values is described using the slanting line patterns, but the patterns that can be selected are not limited to the slanting line patterns. A coding method of dot ON/OFF or a coding method depending on the direction in which the dot position is shifted from the reference position can also be adopted.

Next, the image formation apparatus 400 will be discussed in detail.

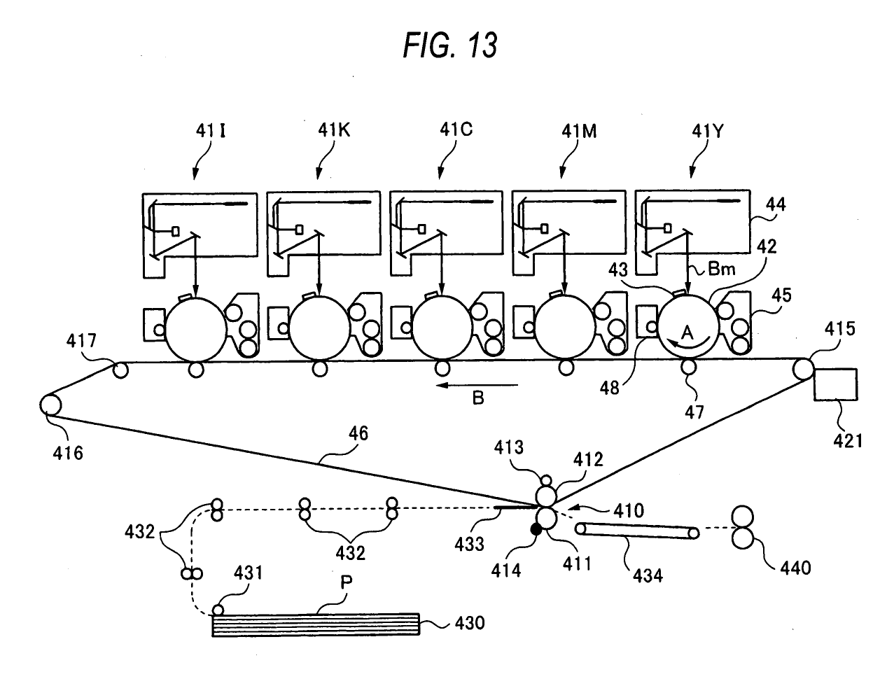

FIG. 13 is a drawing to show a configuration example of the image formation apparatus 400. The image formation apparatus 400 shown in FIG. 13 is a tandem apparatus; for example, it includes a plurality of image formation units 41 (41Y, 41M, 41C, 41K, and 41I) for forming toner images of color components electrophotographically, an intermediate transfer belt 46 for transferring the color component toner images formed in the image formation units 41 in sequence (primary transfer) and retaining the color component toner images, a secondary transfer unit 410 for transferring the overlap image transferred onto the intermediate transfer belt 46 onto paper (medium) P in batch (secondary transfer), and a fuser 440 for fixing the secondarily transferred image onto the paper P.

The image formation apparatus 400 is provided with the image formation unit 41K for forming a black (K) toner image not absorbing infrared and the image formation unit 41I for forming an invisible toner image as the image formation units forming the tandem as well as the image formation units 41Y, 41M, and 41C for forming toner images of yellow (Y), magenta (M), and cyan (C) of commonly used colors (usual colors).

The image formation unit 41I uses a color material absorbing infrared light more than Y toner, M toner, C toner, and K toner used in the image formation units 41Y, 41M, 41C, and 41K. As such a color material, a color material containing vanadium naphthalocyanine can be named, for example. As the K toner used in the image formation unit 41K, it is desirable that a color material less absorbing infrared light than the color material used in the image formation unit 41I should be used for making it easier to detect a code image; however, a generally used color material absorbing infrared light such as a color material containing carbon can also be used.

In the embodiment, in each of the image formation units 41 (41Y, 41M, 41C, 41K, and 41I), disposed in sequence surrounding a photoconductive drum 42 for rotating in the arrow A direction are electrophotographic devices such as a charger 43 for charging the photoconductive drum 42, a laser exposure device 44 for writing an electrostatic latent image onto the photoconductive drum 42 (in the figure, exposure beam is indicated by Bm), a developing device 45 in which the corresponding color component toner is stored for rendering the electrostatic latent image on the photoconductive drum 42 as a visible image in toner, a primary transfer roll 47 for transferring the color component toner images formed on the photoconductive drum 42 onto the intermediate transfer belt 46, and a drum cleaner 48 for removing the remaining toner on the photoconductive drum 42. The image formation units 41 are placed in the order of yellow (Y), magenta (M), cyan (C), black (K), and invisible (I) color upstream of the intermediate transfer belt 46.

The intermediate transfer belt 46 can be rotated in the arrow B direction shown in the figure by means of various rolls of a drive roll 415 for rotating the intermediate transfer belt 46 driven by a motor (not shown), a tension roller 416 having functions of giving constant tension to the intermediate transfer belt 46 and preventing the intermediate transfer belt 46 from meandering, an idle roll 417 for supporting the intermediate transfer belt 46, and a backup roller 412 (described later).

A voltage of the opposite polarity to the toner charge polarity is applied to the primary transfer roll 47, whereby the toner images on the photoconductive drum 42 are electrostatically attracted to the intermediate transfer belt 46 in order and an overlap toner image is formed on the intermediate transfer belt 46. Further, the secondary transfer unit 410 includes a secondary transfer roll 411 pressed against and placed on the toner image support side of the intermediate transfer belt 46 and a backup roller 412 placed on the back of the intermediate transfer belt 46 for forming a counter electrode of the secondary transfer roll 411. A metal feeding roll 413 to which a secondary transfer bias is stably supplied is abutted against and placed on the backup roller 412.

A belt cleaner 421 for cleaning the surface of the intermediate transfer belt 46 after secondary transfer is provided downstream from the secondary transfer roll 411.

Further, in the embodiment, a paper transport system includes a paper tray 430 for storing paper P, a pickup roller 431 for picking up and transporting paper P stacked on the paper tray 430 at a predetermined timing, a transport roll 432 for transporting the paper P paid out by the pickup roller 431, a transport chute 433 for feeding the paper P transported by the transport roll 432 into a secondary transfer position of the secondary transfer unit 410, and a transfer belt 434 for transporting the paper P after secondary transfer to the fuser 440.

Next, the image formation process of the image formation apparatus 400 will be discussed. When the user turns on a start switch (not shown), a predetermined image formation process is executed. Specifically, for example, to implement the image formation apparatus 400 as a color printer, a digital image signal transmitted from the network 900 is temporarily stored in memory and color toner images are formed based on the five-color (Y, M, C, K, and I) digital image signal.

That is, the image formation units 41 (41Y, 41M, 41C, 41K, and 41I) are driven based on color image record signals provided by performing image processing. Each of the image formation units 41Y, 41M, 41C, 41K, and 41I writes an electrostatic latent image responsive to the corresponding image record signal by the laser exposure device 44 onto the photoconductive drum 42 uniformly charged by the charger 43. The image formation unit develops the written electrostatic latent image by the developing device 45 in which the corresponding color toner is stored to form the toner image of the corresponding color.

The toner image formed on each photoconductive drum 42 is primarily transferred from the photoconductive drum 42 onto the surface of the intermediate transfer belt 46 according to a primary transfer bias applied by the primary transfer roll 47 at the primary transfer position where the photoconductive drum 42 and the intermediate transfer belt 46 are in contact with each other. The toner images thus primarily transferred onto the intermediate transfer belt 46 are overlapped on each other on the intermediate transfer belt 46 and are transported to the secondary transfer position with rotation of the intermediate transfer belt 46.

On the other hand, the paper P is transported to the secondary transfer position of the secondary transfer unit 410 at a predetermined timing and the secondary transfer roll 411 nips the paper P relative to the intermediate transfer belt 46 (backup roll 412). The overlap toner image supported on the intermediate transfer belt 46 is secondarily transferred onto the paper P by the action of a secondary transfer electric field formed between the secondary transfer roll 411 and the backup roll 412.

Then, the paper P onto which the toner image is transferred is transported over the transport belt 434 to the fuser 440 for fixing the toner image. On the other hand, the intermediate transfer belt 46 after the secondary transfer has the remaining toner removed by the belt cleaner 421.

The description of the embodiment is now complete.

In the embodiment, the code image represents not only the position information, but also the identification information of the medium or the area, but the identification information is not indispensable. As the identification information, the identification information of the medium or the area is adopted, but any other identification information, such as the identification information of the electronic document printed on the medium, may be adopted.

In the embodiment, an image with a code image and a document image superposed on each other is generated in the identification information management server 200, but the document image need not necessarily be superposed. For example, the invention can also be applied to the case where an image of a code image only is generated in the identification information management server 200 and blank paper (memo paper) with the code image is output.

Further, in the description of the embodiment, the consecutive position information across media is given when an electronic document is printed, but the consecutive position information across media may be given when an original is copied.

As described above, in the embodiment, the consecutive position information across media is given to specific areas on the media. Accordingly, it may become easy to retain the information written onto media collectively.

As described above, the consecutive position information across media is given to specific areas on the media. That is, according to an aspect of the invention, there is provided an image generation apparatus comprising:

an acquisition unit that acquires first position information for determining a position in a first area provided on a first medium plane and second position information for determining a position in a second area provided on a second medium plane, the second position information having continuity with the first position information; and

a generation unit that generates a first code image printed in the first area from the first position information and generates a second code image printed in the second area from the second position information.

According to another aspect of the invention, the image generation apparatus further comprises a combining unit that combines a document image printed on the first medium plane and the first code image and combines a document image printed on the second medium plane and the second code image.

According to another aspect of the invention, in the image generation apparatus, the first position information and the second position information are information having a spread in two different directions and have continuity relative to either of the two directions.

According to another aspect of the invention, in the image generation apparatus, the acquisition unit cuts out partial spaces from the position information space having a spread in two different directions, each size of the partial spaces is same, and acquires the first position information and the second position information by cutting out the partial spaces.

According to another aspect of the invention, in the image generation apparatus, the acquisition unit cuts out partial spaces from the position information space having a spread in two different directions, each size of the partial spaces is different, and acquires the first position information and the second position information by cutting out the partial spaces.

According to another aspect of the invention, in the image generation apparatus, the generation unit generates the first code image and the second code image from common identification information given to the first area and the second area.

According to another aspect of the invention, in the image generation apparatus, the generation unit generates the first code image from identification information of the first medium plane and generates the second code image from identification information of the second medium plane.

The invention may also be grasped as a method of giving the consecutive position information across media to specific areas on the media and printing. In this case, a print method comprises the steps of: acquiring first position information for determining the position in a first area provided on a first medium plane; printing a code image representing the first position information in the first area; acquiring second position information for determining the position in a second area provided on a second medium plane, the second position information having continuity with the first position information; and printing a code image representing the second position information in the second area.

According to another aspect of the invention, in the print method, area size of the first area and the second area are same, the print method further comprising the step of managing the position information space having a spread in two different directions, wherein in the step of acquiring first position information, the first position information is acquired by cutting out a partial space responsive to the area size from the position information space, and wherein in the step of acquiring second position information, the second position information is acquired by cutting out a partial space responsive to the area size from the position information space.

According to another aspect of the invention, the print method further comprises the step of finding the area size based on either of a document image printed on the first medium plane and a document image printed on the second medium plane.

According to another aspect of the invention, the print method further comprises the steps of managing the position information space having a spread in two different directions; finding the size of the first area based on a first document image printed on the first medium plane; and finding the size of the second area based on a second document image printed on the second medium plane, wherein in the step of acquiring first position information, the first position information is acquired by cutting out a partial space responsive to the size of the first area from the position information space, and wherein in the step of acquiring second position information, the second position information is acquired by cutting out a partial space responsive to the size of the second area from the position information space.

According to another aspect of the invention, a storage medium is readable by a computer and stores a program of instructions executable by the computer to perform a function, the function comprises: acquiring first position information for determining a position in a first area provided on a first medium plane and second position information for determining a position in a second area provided on a second medium plane, the second position information having continuity with the first position information; and generating a first code image printed in the first area from the first position information and generating a second code image printed in the second area from the second position information.

According to another aspect of the invention, the generating function is to generate the first code image and the second code image from common identification information given to the first area and the second area.

According to another aspect of the invention, the generating function is to generate the first code image from identification information on the first medium plane and generates the second code image from identification information on the second medium plane.

The invention may also be grasped as a print medium group wherein a predetermined image is printed. In this case, a print medium comprises a first print medium having a first area and a second print medium having a second area, wherein a first code image representing first position information for determining a position in the first area is printed in the first area, and a second code image representing second position information for determining a position in the second area is printed in the second area, the second position information having continuity with the first position information.

According to another aspect of the invention, in the print medium group, the first code image and the second code image further represent common identification information given to the first area and the second area.

According to another aspect of the invention, in the print medium group, the first code image further represents identification information of the first print medium and the second code image further represents identification information of the second print medium.

Further, the invention may also be grasped as an information retention system for retaining information written onto such print media. In this case, an information retention system comprises: a read unit that reads first information written into a first area provided on a first medium plane and second information written into a second area provided on a second medium plane; a recognition unit that recognizes continuity between first position information for determining a position in the first area and second position information for determining a position in the second area; and a retention unit that retains the first information and the second information in a layout responsive to the continuity.

The entire disclosure of Japanese Patent Application No. 2005-266871 filed on Sep. 14, 2005 including specification, claims, drawings and abstract is incorporated herein by reference in its entirety.

What is claimed is:

1. An image generation apparatus comprising:
an acquisition unit that acquires first position information for determining a position in a first area provided on a first medium plane and second position information for determining a position in a second area provided on a second medium plane, the second position information having continuity with the first position information; and
a generation unit that generates a first code image printed in the first area from the first position information and generates a second code image printed in the second area from the second position information.

2. The image generation apparatus as claimed in claim 1, further comprising a combining unit that combines a document image printed on the first medium plane and the first code image and combines a document image printed on the second medium plane and the second code image.

3. The image generation apparatus as claimed in claim 1, wherein the first position information and the second position information are information having a spread in two different directions and have continuity relative to either of the two directions.

4. The image generation apparatus as claimed in claim 1, wherein the acquisition unit cuts out partial spaces from the position information space having a spread in two different directions, each size of the partial spaces is same, and acquires the first position information and the second position information by cutting out the partial spaces.

5. The image generation apparatus as claimed in claim 1, wherein the acquisition unit cuts out partial spaces from the position information space having a spread in two different directions, each size of the partial spaces is different, and acquires the first position information and the second position information by cutting out the partial spaces.

6. The image generation apparatus as claimed in claim 1, wherein the generation unit generates the first code image and the second code image from common identification information given to the first area and the second area.

7. The image generation apparatus as claimed in claim 1, wherein the generation unit generates the first code image from identification information of the first medium plane and generates the second code image from identification information of the second medium plane.

8. A print method comprising the steps of:
acquiring first position information for determining the position in a first area provided on a first medium plane;
printing a code image representing the first position information in the first area;
acquiring second position information for determining the position in a second area provided on a second medium plane, the second position information having continuity with the first position information; and
printing a code image representing the second position information in the second area.

9. The print method as claimed in claim 8, wherein area size of the first area and the second area are same, the print method further comprising the step of managing the position information space having a spread in two different directions,
wherein in the step of acquiring first position information, the first position information is acquired by cutting out a partial space responsive to the area size from the position information space, and
wherein in the step of acquiring second position information, the second position information is acquired by cutting out a partial space responsive to the area size from the position information space.

10. The print method as claimed in claim 9, further comprising the step of finding the area size based on either of a document image printed on the first medium plane and a document image printed on the second medium plane.

11. The print method as claimed in claim 8, further comprising the steps of:
managing the position information space having a spread in two different directions;
finding the size of the first area based on a first document image printed on the first medium plane; and
finding the size of the second are a based on a second document image printed on the second medium plane,
wherein in the step of acquiring first position information, the first position information is acquired by cutting out a partial space responsive to the size of the first area from the position information space, and
wherein in the step of acquiring second position information, the second position information is acquired by cutting out a partial space responsive to the size of the second area from the position information space.

12. A storage medium readable by a computer, the storage medium storing a program of instructions executable by the computer to perform a function, the function comprising:
acquiring first position information for determining a position in a first area provided on a first medium plane and second position information for determining a position in a second area provided on a second medium plane, the second position information having continuity with the first position information; and
generating a first code image printed in the first area from the first position information and generating a second code image printed in the second area from the second position information.

13. The storage medium as claimed in claim 12, wherein the generating function is to generate the first code image and the second code image from common identification information given to the first area and the second area.

14. The storage medium as claimed in claim 12, wherein the generating function is to generate the first code image from identification information on the first medium plane and generates the second code image from identification information on the second medium plane.

15. A print medium comprising a first print medium having a first area and a second print medium having a second area,
wherein a first code image representing first position information for determining a position in the first area is printed in the first area, and
a second code image representing second position information for determining a position in the second area is printed in the second area, the second position information having continuity with the first position information.

16. The print medium group as claimed in claim 15, wherein the first code image and the second code image further represent common identification information given to the first area and the second area.

17. The print medium group as claimed in claim 15, wherein the first code image further represents identification information of the first print medium and the second code image further represents identification information of the second print medium.

18. An information retention system comprising:
a read unit that reads first information written into a first area provided on a first medium plane and second information written into a second area provided on a second medium plane;
a recognition unit that recognizes continuity between first position information for determining a position in the first area and second position information for determining a position in the second area; and
a retention unit that retains the first information and the second information in a layout responsive to the continuity.
